(19) United States
(12) Patent Application Publication
(10) Pub. No.: US 2013/0031323 A1
(43) Pub. Date: Jan. 31, 2013

(54) MEMORY DEVICE SHARING SYSTEM, MANAGING APPARATUS ACCESS CONTROL APPARATUS, METHODS THEREFOR, AND RECORDING MEDIUM

(71) Applicants: Takanori JIN, Shinagawa-ku (JP); Ryuichi ISHIGE, Shinagawa-ku (JP); Yuji OTSU, Shinagawa-ku (JP); Jun OHATA, Sendai-shi (JP); Koh NAKAHASHI, Sendai-shi (JP); Kie KAWANA, Sendai-shi (JP)

(72) Inventors: Takanori JIN, Shinagawa-ku (JP); Ryuichi ISHIGE, Shinagawa-ku (JP); Yuji OTSU, Shinagawa-ku (JP); Jun OHATA, Sendai-shi (JP); Koh NAKAHASHI, Sendai-shi (JP); Kie KAWANA, Sendai-shi (JP)

(73) Assignees: NEC SOFTWARE TOHOKU, LTD., Sendai-shi (JP); NEC BIGLOBE, LTD., Tokyo (JP)

(21) Appl. No.: 13/553,452

(22) Filed: Jul. 19, 2012

(30) Foreign Application Priority Data
Jul. 20, 2011 (JP) 2011-158885

(51) Int. Cl. G06F 12/14

(52) U.S. Cl. 711/163; 711/E12.091

(57) ABSTRACT

A memory device sharing system includes M (M represents an integer of 2 or greater) access control apparatus for sharing N (N represents an integer of 2 or greater) memory devices which store data, and a managing apparatus for managing access to the memory devices via the access control apparatus. The managing apparatus checks data stored in the N memory devices, generates data position information representative of the storage positions of data stored in any one of the N memory devices, and sends the data position information to the M access control apparatus. Each of the M access control apparatuses receives the data position information sent from the manager, and accesses the storage position indicated by the data position information if each of the M access control apparatuses receives an access request to access the data from an access request source.

This application is based upon and claims the benefit of priority from Japanese patent application No. 2011-158885, filed on Jul. 20, 2011, the disclosure of which is incorporated herein in its entirety by reference.

### BACKGROUND OF THE INVENTION

1. Field of the Invention

The present invention relates to a memory device sharing system, a managing apparatus, an access control apparatus, a memory device sharing method, a managing method, an accessing method, and a recording medium.

2. Description of the Related Art

There is known a memory device sharing system wherein a plurality of processors share a plurality of memory devices. The memory device sharing system needs to control access by the processors to the memory devices in order to allow the processors to share the memory devices appropriately.

Patent document 1 (JP2007-48323A) discloses a computer system (memory device sharing system) having a plurality of servers (processors), a plurality of memory devices shared by the servers, and a switch disposed between the servers and the memory devices.

FIG. 1 of the accompanying drawings shows in block form a general layout of the computer system disclosed in Patent document 1.

As shown in FIG. 1, switch 101 is connected to memory unit 101a. Memory unit 101a stores therein a conversion table representing the corresponding relationship between hypothetical storage positions of data and real storage positions of data within memory devices 102P, 102Q.

When switch 101 receives a request to access a hypothetical storage position from a server 103A or 103B which is an WEB server or an application server, switch 101 refers to the conversion table to convert the request to access a hypothetical storage position into a request to access a real storage position, and accesses the real storage position.

With the computer system disclosed in Patent document 1, therefore, server 103A or 103B is able to gain appropriate access to memory device 102P or 102Q by using hypothetical storage positions. Even when any one of memory devices 102P, 102Q is replaced, if the corresponding relationship between hypothetical storage positions and real storage positions in the conversion table in memory unit 101A is changed, then servers 103A, 103B do not need to change the hypothetical storage positions upon replacement of memory device 102P or 102Q.

The computer system disclosed in Patent document 1 necessarily incorporates a switch for each server to access the memory devices. Therefore, the disclosed computer system is disadvantageous in that usage rate tend to concentrate on the switch.

Furthermore, only the switch in the computer system disclosed in Patent document 1 has the conversion table representative of the corresponding relationship between hypothetical storage positions and real storage positions. In the event of a failure of the switch, consequently, each server will be unable to gain access to the memory devices.

### SUMMARY OF THE INVENTION

It is an exemplary object of the present invention to provide a memory device sharing system, a managing apparatus, an access control apparatus, a memory device sharing method, a managing method, an accessing method, and a recording medium storing a program therein which will solve the above problems according to the related art.

A memory device sharing system which includes M (M represents an integer of 2 or greater) access control apparatus that shares N (N represents an integer of 2 or greater) memory devices which store data, the memory device sharing system including a managing apparatus that manages access to the memory devices via the access control apparatus, according to an exemplary aspect of the invention includes:

the managing apparatus that includes a manager which checks data stored in the N memory devices, manager that generates data position information representative of the storage positions of data stored in any one of the N memory devices, and a manager that sends the data position information to the M access control apparatus; and

each of the M access control apparatus that includes:

a communication unit that receives the data position information sent from the manager; and

a controller that accesses the storage position indicated by the data position information if the controller receives an access request to access the data from an access request source.

A managing apparatus, which manages access to N (N represents an integer of 2 or greater) memory devices which store data, by M (M represents an integer of 2 or greater) access control apparatus which shares the N memory devices, according to an exemplary aspect of the invention includes:

a manager for checking data stored in the N memory devices, generating data position information representative of the storage positions of data stored in any one of the N memory devices, and sending the data position information to the M access control apparatus.

An access control apparatus that shares N (N represents an integer of 2 or greater) memory devices with other access control apparatus, the access control apparatus being capable of communicating with a managing apparatus, according to an exemplary aspect of the invention includes:

a communication unit that receives data position information representative of the storage position of data stored in any one of the N memory devices, from the managing apparatus; and

a controller that accesses the storage position indicated by the data position information if the controller receives an access request to access the data from an access request source.

A memory device sharing method to be carried out by a memory device sharing system including M (M represents an integer of 2 or greater) access control apparatus that shares N (N represents an integer of 2 or greater) memory devices which store data, the memory device sharing system including a managing apparatus that manages access to the memory devices via the access control apparatus, according to an exemplary aspect of the invention includes:

the managing apparatus that checks data stored in the N memory devices, generates data position information representative of the storage positions of data stored in any one of the N memory devices, and sends the data position information to the M access control apparatus;

each of the M access control apparatus that receives the data position information sent from the manager; and

each of the M access control apparatuses that accesses the storage position indicated by the data position information if each of the M access control apparatuses receives an access request to access the data from an access request source.

A managing method to be carried out by a managing apparatus that manages access to N (N represents an integer of 2 or greater) memory devices which store data, via M (M represents an integer of 2 or greater) access control apparatus which shares the N memory devices, according to an exemplary aspect of the invention includes:

checking data stored in the N memory devices, generating data position information representative of the storage positions of data stored in any one of the N memory devices, and sending the data position information to the M access control apparatus.

An accessing method to be carried out via an access control apparatus that shares N (N represents an integer of 2 or greater) memory devices with other access control apparatuses, the access control apparatus being capable of communicating with a managing apparatus, according to an exemplary aspect of the invention includes:

receiving data position information representative of the storage position of data stored in any one of the N memory devices, from the managing apparatus; and

accessing the storage position indicated by the data position information if the access control apparatus receives an access request to access the data from an access request source.

A computer readable recording medium, according to an exemplary aspect of the invention, that records a program that causes a computer to perform procedures includes:

managing a sequence for checking data stored in N (N represents an integer of 2 or greater) memory devices which store data, for generating data position information representative of the storage positions of data stored in any one of the N memory devices, and for sending the data position information to M (M represents an integer of 2 or greater) access control apparatus which shares the N memory devices.

A computer readable recording medium, according to an exemplary aspect of the invention, that records a program that causes a computer, which shares N (N represents an integer of 2 or greater) memory devices with other computers and which is capable of communicating with a managing apparatus, to perform procedures includes:

a receiving sequence for receiving data position information representative of the storage position of data stored in any one of the N memory devices, from the managing apparatus; and

a control sequence for accessing the storage position indicated by the data position information if an access request to access the data is received from an access request source.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram showing a general layout of a computer system disclosed in Patent document 1;

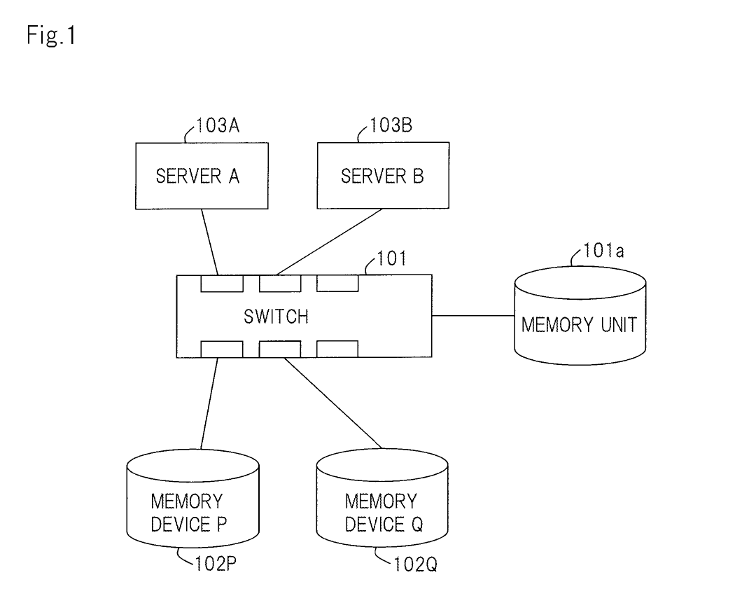

FIG. 2 is a block diagram of a memory device sharing system according to an exemplary embodiment of the present invention;

FIG. 3 is a diagram showing a storage position table by way of example;

FIG. 4 is a diagram showing a memory device attribute table by way of example;

FIG. 5 is a diagram showing a priority order table by way of example; and

FIG. 6 is a sequence diagram illustrative of the manner in which the memory device sharing system operates.

### DETAILED DESCRIPTION OF THE EXEMPLARY EMBODIMENT

A memory device sharing system according to an exemplary embodiment of the present invention will be described below.

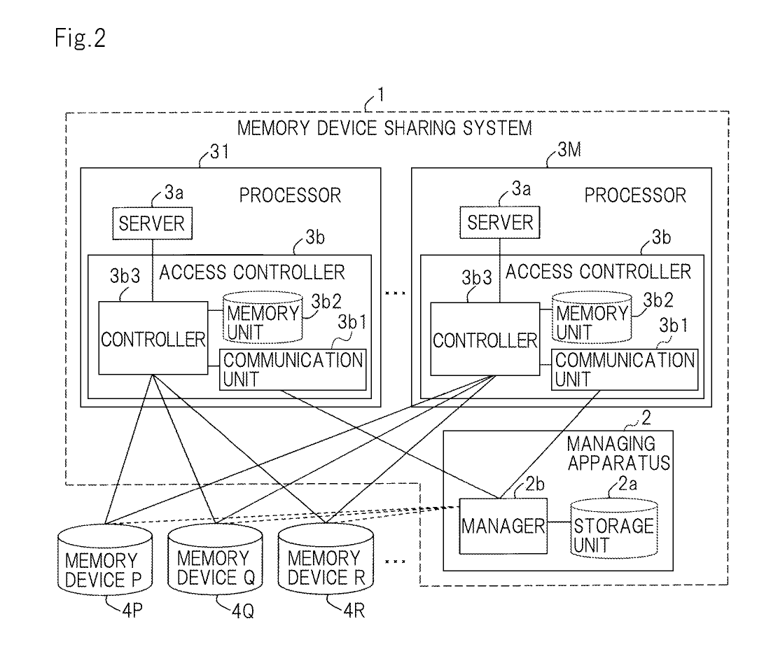

FIG. 2 shows in block form memory device sharing system 1 according to an exemplary embodiment of the present invention.

As shown in FIG. 2, memory device sharing system 1 includes managing apparatus 2 and M (M represents an integer of 2 or greater) processors 3. FIG. 2 shows only two processors 31, 3M out of M processors 3 for the sake of brevity. Managing apparatus 2 includes storage unit 2a and manager 2b. Each of M processors 3 includes server 3a and access controller 3b. Access controller 3b3 includes communication unit 3b1, memory unit 3b2, and controller 3b3. M processors 3, or stated otherwise, M access controllers 3b3, share N (N represents an integer of 2 or greater) memory devices 4. FIG. 2 shows only memory devices 4P, 4Q, 4R out of N memory devices 4 for the sake of brevity. As described above, the number of N memory devices 4 is not limited to three or more, but may be two. Memory device 4P will hereinafter be referred to as “memory device P”, memory device 4Q as “memory device Q”, and memory device 4R as “memory device R”.

Managing apparatus 2 will be described below.

Managing apparatus 2 controls access by M access to N memory devices 4 via controllers 3b.

Storage unit 2a stores a storage position table, a memory device attribute table, and a priority order table. The storage position table serves as an example of data position information. The memory device attribute table serves as an example of memory device information.

The storage position table represents the storage position of each of files that are stored in any one of N memory devices 4. According to the present exemplary embodiment, the storage position table is generated and updated by manager 2b. The files serve as an example of data.

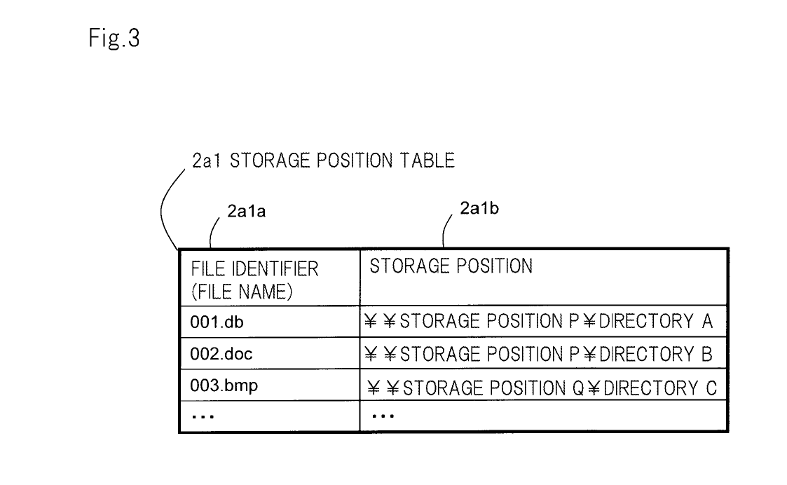

FIG. 3 shows the storage position table by way of example.

As shown in FIG. 3, storage position table 2a1 includes file identifiers 2a1a which identify respective files that are stored in any one of N memory devices 4 and storage positions 2a1b of the respective files.

Each of file identifiers 2a1a represents a file name, for example. Each of storage positions 2a1b is made up of a memory device identifier for identifying memory device 4 and a directory name. The memory device identifier may be the name of memory device 4 or the IP (Internet Protocol) address of memory device 4, for example.

The memory device attribute table indicates whether data can be read from, newly written into or updated in each of N memory devices 4. The memory device attribute table is generated by the administrator of managing apparatus 2, and updated depending on an input from the administrator of managing apparatus 2 or by manager 2b, for example.

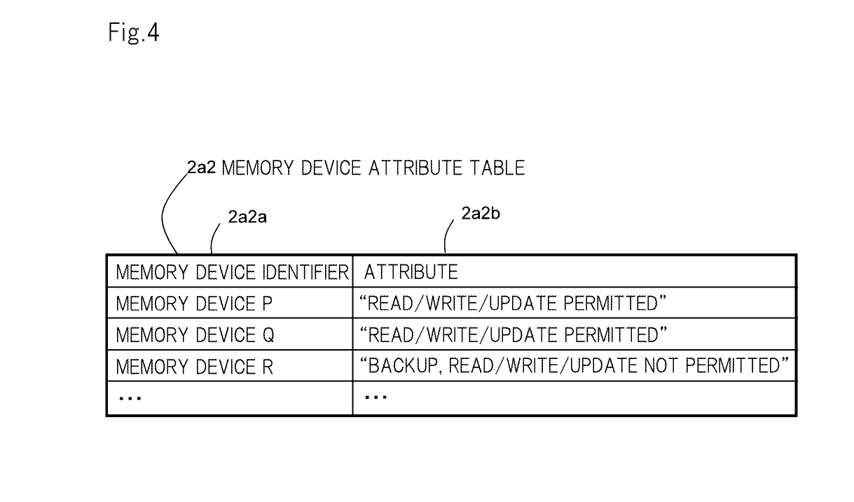

FIG. 4 shows the memory device attribute table by way of example.

As shown in FIG. 4, memory device attribute table 2a2 includes memory device identifiers 2a2a which identify respective memory devices 4 and attributes 2a2b thereof.

Attributes 2a2b indicate whether files can be read from or newly written into, or updated in respective memory devices 4.

According to the present exemplary embodiment, each of attributes 2a2b represents either “READ/WRITE/UPDATE PERMITTED” that indicates permission to read files, permission to write new files and permission to update files, or “BACKUP, READ/WRITE/UPDATE NOT PERMITTED” that indicates preventing the reading of all files, preventing the writing of new files, preventing the updating of files, or “READ/UPDATE PERMITTED, WRITE NOT PERMITTED” that indicates permission to read files, permission to update files and preventing the writing of new files. Each of attributes 2a2b, however, is not limited to “READ/WRITE/UPDATE PERMITTED”, “BACKUP, READ/WRITE/UPDATE NOT PERMITTED”, and “READ/UPDATE PERMITTED, WRITE NOT PERMITTED”, but may be changed as desired.

The priority order table represents a priority order with respect to N memory devices 4. The priority order table is generated by the administrator of managing apparatus 2, and updated depending on an input from the administrator of managing apparatus 2 or by manager 2b, for example.

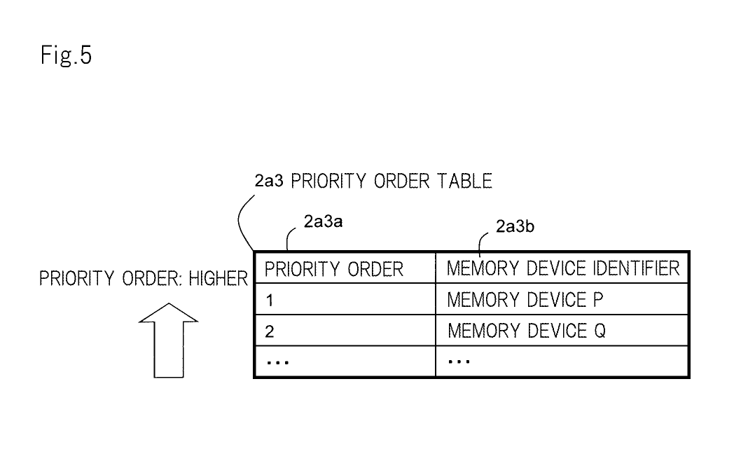

FIG. 5 shows the priority order table by way of example.

As shown in FIG. 5, priority order table 2a3 gives priority “1” to memory device 4P, and priority “2” to memory device 4Q. In priority order table 2a3 according to the present exemplary embodiment, since the numerical value of priority order 2a3a is higher, a higher priority is given. In priority order table 2a3, therefore, the highest priority is given to memory device 4P, and the second highest priority is given to memory device 4Q.

Priority order table 2a3 also includes memory device identifier 2a3b as information which identifies each memory device 4.

Priority order table 2a3 indicates, as the highest priority, the priority of a memory device to be newly added as memory device 4 which will be shared by M access controllers 3b.

In FIG. 2, manager 2b can generally be referred to as managing means.

Manager 2b manages operation of managing apparatus 2.

For example, manager 2b accesses N memory devices 4, checks the files (e.g., file names) stored in N memory devices 4, and generates storage position table 2a1 (see FIG. 3) based on the results of the check. Manager 2b may access N memory devices 4 at predetermined time intervals of 3 seconds, or at times depending on the times at which access instructions are given from the administrator of managing apparatus 2. The predetermined time intervals referred to above are not limited to 3 seconds, but may be changed as desired. Manager 2b stores storage position table 2a1 into storage unit 2a. Manager 2b also reads storage position table 2a1 from storage unit 2a and sends storage position table 2a1 to M access controllers 3b.

Manager 2b moves files between memory devices 4, e.g., between memory device 4P and memory device 4R. Depending on the movement of files, manager 2b updates storage position table 2a1 in storage unit 2a. Manager 2b reads updated storage position table 2a1 from storage unit 2a and sends updated storage position table 2a1 to M access controllers 3b. Updated storage position table 2a1 shows an example of moved data.

When memory device attribute table 2a2 is stored in storage unit 2a, or when memory device attribute table 2a2 in storage unit 2a is updated, for example, manager 2b reads memory device attribute table 2a2 from storage unit 2a, and sends memory device attribute table 2a2 to M access controllers 3b.

Furthermore, when priority order table 2a3 is stored in storage unit 2a, or when priority order table 2a3 in storage unit 2a is updated, for example, manager 2b reads priority order table 2a3 from storage unit 2a, and sends priority order table 2a3 to M access controllers 3b.

According to the present exemplary embodiment, manager 2b monitors the usage rate of a memory device, i.e., memory device 4 in use, for which attribute 2a2b in memory device attribute table 2a2 indicates “READ/WRITE/UPDATE PERMITTED” or “READ/UPDATE PERMITTED, WRITE NOT PERMITTED”, among N memory devices 4. The usage rate may refer to the access frequency or the file usage capacity (idle storage capacity).

Based on the monitored result, manager 2b updates memory device attribute table 2a2 and priority order table 2a3. Then, manager 2b sends updated memory device attribute table 2a2 and updated priority order table 2a3 to M access controllers 3b.

M processors 3 will be described below.

M processors 3 share the files (data) stored in N memory devices 4. Processors 3 perform a distributing process, for example.

Server 3a serves as an example of an access request source.

Server 3a is a WEB server or an application server, for example, and issues a request to access memory devices 4 in response to a request from a client, not shown.

The request to access memory devices 4 is either a request (hereinafter referred to as “read request”) for reading a file that is present in any one of N memory devices 4, or a request (hereinafter referred to as “write request”) for writing a new file into any one of N memory devices 4, or a request (hereinafter referred to as “update request”) for updating a file that is present in any one of N memory devices 4. Server 3a sends a request to access memory devices 4, i.e., a read request, a write request, or an update request, to access controller 3b or more specifically controller 3b3.

Access controller 3b can be generally referred to as an access control device.

Access controller 3b receives storage position table 2a1, memory device attribute table 2a2, and priority order table 2a3 that are sent from manager 2b. When access controller 3b receives a request to access memory devices 4, access controller 3b controls access to memory devices 4 based on storage position table 2a1, memory device attribute table 2a2, and priority order table 2a3.

Communication unit 3b1, which can be generally referred to as communication means, receives storage position table 2a1, memory device attribute table 2a2, priority order table 2a3, updated storage position table 2a1, updated memory device attribute table 2a2, and updated priority order table 2a3 that are sent from manager 2b.

Memory unit 3b2, which can be generally referred to as memory means, stores storage position table 2a1, memory device attribute table 2a2, priority order table 2a3 that are received by communication unit 3b1.

Controller 3b3, which can be generally referred to as control means, controls operation of access controller 3b.

For example, when server 3a issues a request to access a file (hereinafter referred to as “file A”) stored in any one of N memory devices 4, controller 3b3 accesses the storage position of file A indicated in stores storage position table 2a1 in response to the issuance of the access request.

When communication unit 3b1 receives updated storage position table 2a1, controller 3b3 updates storage position table 2a1 stored in memory unit 3b2 into updated storage position table 2a1.

When communication unit 3b1 receives updated memory device attribute table 2a2, controller 3b3 updates memory device attribute table 2a2 stored in memory unit 3b2 into updated memory device attribute table 2a2.

When communication unit 3b1 receives updated priority order table 2a3, controller 3b3 updates priority order table 2a3 stored in memory unit 3b2 into updated priority order table 2a3.

According to the present exemplary embodiment, when server 3a issues a request to update file A, controller 3b3 identifies memory device 4 (hereinafter referred to as “relevant memory device 4”) which stores file A by referring to the storage position of file A which is indicated in storage position table 2a1. Controller 3b3 refers to memory device attribute table 2a2, and if controller 3b3 confirms that the updating of the files in the relevant memory device is permitted, then controller 3b3 accesses the storage position of file A which is indicated in storage position table 2a1.

Operation of memory device sharing system 1 will be described below.

Manager 2b in managing apparatus 2 accesses N memory devices 4, checks the files stored in N memory devices 4, and generates storage position table 2a1 based on the results of the check.

Manager 2b then stores generated storage position table 2a1 in storage unit 2a.

Then, manager 2b reads storage position table 2a1 from storage unit 2a and sends storage position table 2a1 to M access controllers 3b.

In each of M access controllers 3b, communication unit 3b1 receives storage position table 2a1 that is sent from manager 2b, and sends received storage position table 2a1 to controller 3b3.

Controller 3b3 stores received storage position table 2a1 in memory unit 3b2. If a storage position table has already been stored in memory unit 3b2 when controller 3b3 receives storage position table 2a1, controller 3b3 updates the storage position table stored in memory unit 3b2 in storage position table 2a1 received from communication unit 3b1.

When memory device attribute table 2a2 is stored in storage unit 2a and memory device attribute table 2a2 stored in storage unit 2a is updated, for example, manager 2b reads memory device attribute table 2a2 from storage unit 2a.

When manager 2b reads memory device attribute table 2a2 from storage unit 2a, manager 2b sends memory device attribute table 2a2 to M access controllers 3b.

In each of M access controllers 3b, communication unit 3b1 receives memory device attribute table 2a2 that is sent from manager 2b. Communication unit 3b1 sends received memory device attribute table 2a2 to controller 3b3.

Controller 3b3 stores received memory device attribute table 2a2 in memory unit 3b2. If a memory device attribute table has already been stored in memory unit 3b2 when controller 3b3 receives memory device attribute table 2a2, controller 3b3 updates the memory device attribute table stored in memory unit 3b2 into memory device attribute table 2a2 received from communication unit 3b1.

When priority order table 2a3 is stored in storage unit 2a and priority order table 2a3 stored in storage unit 2a is updated, for example, manager 2b reads priority order table 2a3 from storage unit 2a.

When manager 2b reads priority order table 2a3 from storage unit 2a, manager 2b sends priority order table 2a3 to M access controllers 3b.

In each of M access controllers 3b, communication unit 3b1 receives priority order table 2a3 that is sent from manager 2b. Communication unit 3b1 sends received priority order table 2a3 to controller 3b3.

Controller 3b3 stores received priority order table 2a3 into memory unit 3b2. If a memory device attribute table has already been stored in memory unit 3b2 when controller 3b3 receives priority order table 2a3, controller 3b3 updates the memory device attribute table stored in memory unit 3b2 into priority order table 2a3 received from communication unit 3b1.

Operation of manager 2b to move files between memory devices 4 will be described below. It is assumed below that memory unit 3b2 in each of access controllers 3b and storage unit 2a in managing apparatus 2 store storage position table 2a1 shown in FIG. 3, memory device attribute table 2a2 shown in FIG. 4, and priority order table 2a3 shown in FIG. 5, and that memory device 4R is not in use.

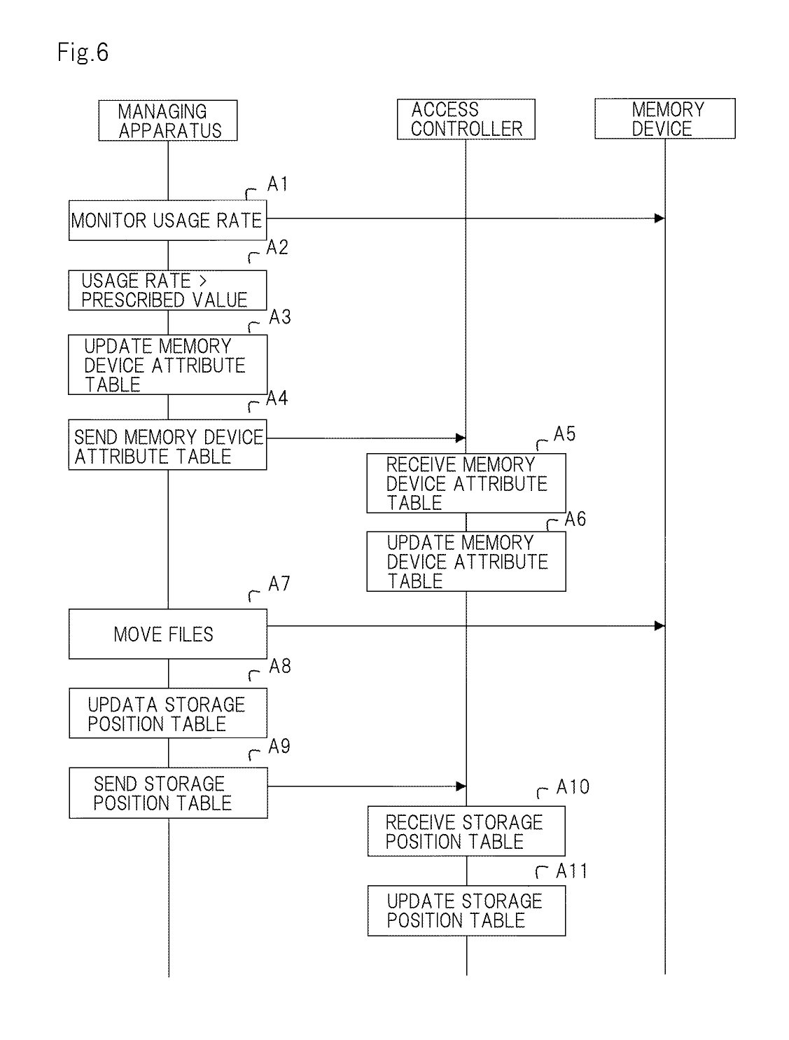

FIG. 6 is a sequence diagram illustrative of the manner in which memory device sharing system 1 operates for manager 2b to move files between memory devices 4. In FIG. 6, only one access controller 3b and only one memory device 4 are illustrated for the sake of brevity. Actually, however, there are a plurality of access controllers 3b and a plurality of memory devices 4.

Manager 2b monitors the usage rates of memory devices in use, i.e., memory devices 4P, 4Q (or a single memory device), for which attribute 2a2b in memory device attribute table 2a2 indicates “READ/WRITE/UPDATE PERMITTED” or “READ/UPDATE PERMITTED, WRITE NOT PERMITTED” (step A1).

Then, manager 2b compares each of the usage rates of memory devices 4P, 4Q with a prescribed value (step A2). If each of the usage rates of memory devices 4P, 4Q does not exceed the prescribed value, then control goes back to step A1.

It is assumed hereinafter that the usage rate of memory device 4P is in excess of the prescribed value.

If the usage rate of memory device 4P is in excess of the prescribed value, then manager 2b updates attribute 2a2b for memory device 4R not in use in memory device attribute table 2a2 stored in storage unit 2a from “BACKUP, READ/WRITE/UPDATE NOT PERMITTED” to “READ/WRITE PERMITTED” (step A3). At this time, manager 2b may update priority order table 2a3 such that the priority of memory device 4R will be the highest.

After having updated memory device attribute table 2a2 stored in storage unit 2a, manager 2b sends updated memory device attribute table 2a2 simultaneously to access controllers 3b in respective processors 3 (step A4). If priority order table 2a3 has also been updated in step A3, then manager 2b also sends updated priority order table 2a3 simultaneously to access controllers 3b in respective processors 3 in step A4.

In each of access controllers 3b, communication unit 3b1 receives updated memory device attribute table 2a2 (step A5). Communication unit 3b1 then sends updated memory device attribute table 2a2 to controller 3b3. If communication unit 3b1 receives updated priority order table 2a3 together with updated memory device attribute table 2a2 in step A5, then communication unit 3b1 also sends updated priority order table 2a3 to controller 3b3.

When controller 3b3 receives updated memory device attribute table 2a2, controller 3b3 updates memory device attribute table 2a2 stored in memory unit 3b2 into updated memory device attribute table 2a2 (step A6). If controller 3b3 also receives updated priority order table 2a3, then controller 3b3 also updates priority order table 2a3 stored in memory unit 3b2 into updated priority order table 2a3.

If no memory device attribute table has been stored in memory unit 3b2, then controller 3b3 stores updated memory device attribute table 2a2 into memory unit 3b2. If no priority order table has been stored in memory unit 3b2, then controller 3b3 stores updated priority order table 2a3 into memory unit 3b2.

When the updating of memory device attribute table 2a2 stored in memory unit 3b2 into updated memory device attribute table 2a2 or the storage of updated memory device attribute table 2a2 into memory unit 3b2 is normally finished, controller 3b3 may send response information indicative of the normal finish through communication unit 3b1 to managing apparatus 2.

Furthermore, when the updating of priority order table 2a3 stored in memory unit 3b2 into updated priority order table 2a3 or the storage of updated priority order table 2a3 into memory unit 3b2 is normally finished, controller 3b3 may send response information indicative of the normal finish through communication unit 3b1 to managing apparatus 2.

Manager 2b in managing apparatus 2 moves files from memory device 4P whose usage rate is in excess of the prescribed value to memory device 4R as long as the usage rate of memory device 4R remains below the prescribed value (step A7).

For example, if old memory device 4P is replaced with new memory device 4R, then the administrator of managing apparatus 2 may give manager 2b a moving instruction to move all the files in memory device 4P to memory device 4R, and manager 2b may move all the files in memory device 4P to memory device 4R according to the moving instruction.

If a memory device to be newly added (memory device 4R in the above example) is not available when the usage rate of memory device 4P exceeds the prescribed value, then manager 2b moves the files in memory device 4P to memory device 4 whose usage rate is the lowest among memory devices 4 in use, thereby leveling the usage rates of memory devices 4 in use.

If the access frequency is used as the usage rate, then manager 2b may extract files to be moved from memory device 4P in the descending order of access frequencies thereof. If the file usage capacity (idle storage capacity) is used as the usage rate, then manager 2b may extract files to be moved from memory device 4P which have not been used for a predetermined period of time. In this manner, manager 2b extracts files to be moved such that loads (usage rates) will be equally reduced among memory devices 4 in use.

Then, manager 2b updates storage position table 2a1 in storage unit 2a in order to reflect the results of the movement of the files depending on the movement of the files, e.g., immediately after the movement of the files is finished (step A8).

For example, when manager 2b has moved file “001.db” in memory device 4P to directory D of memory device 4R, manager 2b updates storage position 2a1b of file “001.db” in storage position table 2a1 shown in FIG. 3 from “¥ ¥ STORAGE POSITION P ¥ DIRECTORY A” to ¥ ¥ STORAGE POSITION R ¥ DIRECTORY D.

After having updated storage position table 2a1 stored in storage unit 2a, manager 2b sends updated storage position table 2a1 simultaneously to access controllers 3b in respective processors 3 (step A9).

In each of access controllers 3b, communication unit 3b1 receives updated storage position table 2a1 (step A10), and outputs updated storage position table 2a1 to controller 3b3.

When controller 3b3 receives updated storage position table 2a1, controller 3b3 updates storage position table 2a1 stored in memory unit 3b2 into updated storage position table 2a1 (step A11).

If no storage position table has been stored in memory unit 3b2, then controller 3b3 stores updated storage position table 2a1 into memory unit 3b2.

When the updating of storage position table 2a1 stored in memory unit 3b2 into updated storage position table 2a1 or the storage of updated storage position table 2a1 into memory unit 3b2 is normally finished, controller 3b3 may send response information indicative of the normal finish through communication unit 3b1 to managing apparatus 2.

Operation of memory device sharing system 1 at the time access controller 3b receives an access request from server 3a will be described below.

If the access request is a request to read file A, then controller 3b3 refers to storage position table 2a1 stored in memory unit 3b2, reads the storage position of file A from storage position table 2a1, accesses the storage position of file A, reads file A, and outputs file A to server 3a.

If storage position table 2a1 does not indicate the storage position of file A, then controller 3b3 successively accesses memory devices 4 in use. If file A is stored in any one of memory devices 4 in use, then controller 3b3 reads file A from memory device 4 which is storing file A, and outputs file A to server 3. If file A is not stored in any one of memory devices 4 in use, then controller 3b3 outputs a notice indicating that file A cannot be found to server 3a.

If the access request is a request to update file A, then controller 3b3 refers to storage position table 2a1 and memory device attribute table 2a2 stored in memory unit 3b2, reads the storage position of file A from storage position table 2a1. If memory device attribute table 2a2 indicates that there is permission to update data in memory device 4, which is identified by the storage position of file A, then controller 3b3 accesses the storage position of file A and updates file A according to the request to update file A. If memory device attribute table 2a2 does not indicate that there is permission to update data in memory device 4, which is identified by the storage position of file A, then controller 3b3 outputs a notice indicating that the updating of file A is inhibited to server 3a.

If storage position table 2a1 does not indicate the storage position of file A, then controller 3b3 successively accesses memory devices 4 in use. If file A is stored in any one of memory devices 4 in use, then provided that memory device attribute table 2a2 indicates permission to update data in memory device 4 which is storing file A, controller 3b3 accesses the storage position of file A and updates file A according to the request to update file A. If file A is not stored in any one of memory devices 4 in use, then controller 3b3 outputs a notice to server 3a indicating that file A cannot be found.

If the access request is a request to write a new file, then controller 3b3 refers to priority order table 2a3 stored in memory unit 3b2, and writes the new file into memory device 4 whose priority is the highest.

Advantages of the present exemplary embodiment will be described below.

According to the present exemplary embodiment, manager 2b checks the files stored in N memory devices 4, generates storage position table 2a1, and sends generated storage position table 2a1 to M access controllers 3b. In each of access controllers 3b, communication unit 3b1 receives storage position table 2a1 that is sent from manager 2b. When controller 3b3 receives a request to access file A from server 3a, controller 3b3 access the storage position of file A which is indicated in storage position table 2a1.

Therefore, managing apparatus 2 controls access to memory devices 4 via controllers 3b by sending storage position table 2a1 to access controllers 3b. As managing apparatus 2 does not need to receive access requests from access controllers 3b, the concentration of loads in managing apparatus 2 is prevented.

In the event that a fault occurs in managing apparatus 2, each of access controller 3b is capable of continuing information processing using N memory devices 4 because of storage position table 2a1 stored in each access controller 3b even while managing apparatus 2 is being replaced with a new managing apparatus.

According to the present exemplary embodiment, manager 2b moves files between memory devices 4, and sends the results of the movement of the files (updated storage position table 2a1) to M access controllers 3b. Communication unit 3b1 receives the results of the movement of the files that are sent from manager 2b. Controller 3b3 updates storage position table 2a1 stored in memory unit 3b2 based on the results of the movement of the data that are received by communication unit 3b1. When controller 3b3 receives an access request, controller 3b3 accesses the storage position indicated by storage position table 2a1 stored in memory unit 3b2.

Therefore, since each access controller 3b accesses a moved file using storage position table 2a1 that is updated based on the results of the movement of the data, the accessing process is made efficient, reducing the load on memory device sharing system 1.

Heretofore, when memory device 4 is to be replaced, all files in the old memory device are copied to a new memory device (if a copy failure occurs, then a re-copying process is carried out from the start), and then access to memory device 4 is stopped, after which memory device 4 is replaced. According to the present exemplary embodiment, memory device 4 can be replaced without stopping access to memory device 4.

According to the present exemplary embodiment, if the access request is a request to read file A, then controller 3b3 access the storage position of file A which is indicated in storage position table 2a1, reads file A, and outputs file A to server 3a. Consequently, it is possible to make efficient the accessing process based on the request to read file A.

According to the present exemplary embodiment, if the access request is a request to update file A, then provided that memory device attribute table 2a2 indicates permission to update data in memory device 4 which is identified by the storage position of file A, controller 3b3 accesses the storage position of file A and updates file A according to the request to update file A. Therefore, it is possible to control permission or non-permission to update a file in each memory device.

According to the present exemplary embodiment, when memory unit 3b2 stores storage position table 2a1 or memory device attribute table 2a2 and communication unit 3b1 sends response information to manager 2b, if there are controllers (hereinafter referred to as “first specific controllers”), among the controllers 3b3, which do not send response information within a preset time (e.g., 5 seconds) after storage position table 2a1 has been sent, or if there are controllers (hereinafter referred to as “second specific controllers”), among the controllers 3b3, which do not send response information within a preset time after memory device attribute table 2a2 has been sent, then manager 2b may prevent the first specific controllers and the second specific controllers from using N memory devices 4.

Thus, the first specific controllers, i.e., controllers 3b3 in access controllers 3b which are highly likely to have failed to receive new storage position table 2a1, are prevented from accessing memory devices 4 using old storage position table 2a1, and the second specific controllers, i.e., controllers 3b3 in access controllers 3b which are highly likely to have failed to receive new memory device attribute table 2a2, are prevented from accessing memory devices 4 using old memory device attribute table 2a2.

The first specific controllers and the second specific controllers may be prevented from using N memory devices 4 by not permitting the first specific controllers and the second specific controllers to access N memory devices 4 or by setting N memory devices 4 to refuse packets that use IP addresses of the first specific controllers and the second specific controllers, for example. The preset time referred to above is not limited to 5 seconds, but may be changed as desired.

Manager 2b may equalize the times at which storage position table 2a1 is stored in memory units 3b2 in respective access controllers 3b. For example, manager 2b may use a distribution commit algorithm (also known as “distribution algorithm”) such as a two-phase commit algorithm, a three-phase commit algorithm, or a paxos algorithm for all access controllers 3b to update storage position table 2a1 at the same time.

In this case, since all access controllers 3b update storage position table 2a1 at the same time, it is possible to ensure improved consistency of access to memory devices 4 via access controllers 3b.

In respective access controllers 3b, memory device attribute table 2a2 may be stored into memory units 3b2 at equalized times, and priority order table 2a3 may be stored into memory units 3b2 at equalized times.

Memory device attribute table 2a2 may be updated not only when the usage rate of certain memory device 4 exceeds the prescribed value. Rather, memory device attribute table 2a2 may be updated when one of memory devices 4 fails, or when the monitored status of memory devices 4, i.e., the monitored incidence rate of read errors, is reported, or at various times according to a maintenance plan for memory devices 4.

Managing apparatus 2 may be implemented by a computer. The computer functions as storage unit 2a and manager 2b by reading and executing a program recorded in a recording medium such as a CD-ROM (Compact Disk Read Only Memory) that is readable by the computer.

Each of access controllers 3b may be implemented by a computer. The computer functions as access controller 3b by reading and executing a program recorded in a recording medium that is readable by the computer.

The recording medium is not limited to a CD-ROM, but may be changed as desired.

According to the advantages of the present invention, while access by processors to recording devices is being controlled, the concentration of loads on certain devices is prevented, and each of the processors is capable of appropriately accessing the recording devices even in the event that a fault occurs in a managing apparatus.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A memory device sharing system comprising M (M represents an integer of 2 or greater) access control apparatus that shares N (N represents an integer of 2 or greater) memory devices which store data, said memory device sharing system comprising a managing apparatus that manages access to said memory devices via said access control apparatus, wherein
said managing apparatus includes a manager that checks data stored in said N memory devices, generates data position information representative of the storage positions of data stored in any one of said N memory devices, and sends said data position information to said M access control apparatus; and
each of said M access control apparatus comprises:
a communication unit that receives the data position information sent from said manager; and
a controller that accesses the storage position indicated by said data position information if said controller receives an access request to access the data from an access request source.

2. The memory device sharing system according to claim 1, wherein each of said M access control apparatus further comprises:
a memory unit that stores the data position information received by said communication unit;
said manager that moves said data between said memory devices and sends the results of the movement of said data to said M access control apparatus;
said communication unit that receives the results of the movement of said data which are sent from said manager; and
said controller that updates the data position information stored in said memory unit based on the results of the movement of said data which are received by said communication unit, and accesses the storage position indicated by said data position information if said controller receives the access request.

3. The memory device sharing system according to claim 1, wherein if said access request is a request to read said data, then said controller accesses the storage position indicated by said data position information, reads said data, and outputs the data to said access request source.

4. The memory device sharing system according to claim 1, wherein said manager sends memory device information representative of whether or not the updating of data in each of said N memory devices is permitted, to said M access control apparatus;
said communication unit receives the memory device information which is sent from said manager; and
if said access request is a request to update said data, then provided that said memory device information indicates that the updating of the data in the recording device which is identified by said storage position is permitted, said controller accesses said storage position and updates said data according to the request to update said data.

5. The memory device sharing system according to claim 1, wherein each of said M access control apparatuses further includes a memory unit that stores the data position information which is received by said communication unit;
when said memory unit stores said data position information, said controller sends response information through said communication unit to said managing apparatus; and
if there is a specific controller, among the controllers, which has failed to send said response information within a preset time after said data position information is sent, then said manager prevents said specific controller from using said N memory devices.

6. A managing apparatus managing access to N (N represents an integer of 2 or greater) memory devices which store data, via M (M represents an integer of 2 or greater) access control apparatus which shares the N memory devices, comprising:
a manager that checks data stored in said N memory devices, generates data position information representative of the storage positions of data stored in any one of said N memory devices, and sends said data position information to said M access control apparatus.

7. An access control apparatus that shares N (N represents an integer of 2 or greater) memory devices with other access control apparatus, said access control apparatus being capable of communicating with a managing apparatus, comprising:
a communication unit that receives data position information representative of the storage position of data stored in any one of said N memory devices, from said managing apparatus; and
a controller that accesses the storage position indicated by said data position information if said controller receives an access request to access the data from an access request source.

8. A memory device sharing method to be carried out by a memory device sharing system including M (M represents an integer of 2 or greater) access control apparatus that shares N (N represents an integer of 2 or greater) memory devices which store data, said memory device sharing system including a managing apparatus that manages access to said memory devices via said access control apparatus, wherein
said managing apparatus checks data stored in said N memory devices, generates data position information representative of the storage positions of data stored in any one of said N memory devices, and sends said data position information to said M access control apparatus;
each of said M access control apparatuses receives the data position information sent from said manager; and
each of said M access control apparatuses accesses the storage position indicated by said data position information if each of said M access control apparatuses receives an access request to access the data from an access request source.

9. A managing method to be carried out by a managing apparatus that manages access to N (N represents an integer of 2 or greater) memory devices which store data, via M (M represents an integer of 2 or greater) access control apparatus which shares the N memory devices, comprising:
checking data stored in said N memory devices, generating data position information representative of the storage positions of data stored in any one of said N memory devices, and sending said data position information to said M access control apparatus.

10. An accessing method to be carried out by an access control apparatus that shares N (N represents an integer of 2 or greater) memory devices with other access control apparatuses, said access control apparatus being capable of communicating with a managing apparatus, comprising:
receiving data position information representative of the storage position of data stored in any one of said N memory devices, from said managing apparatus; and
accessing the storage position indicated by said data position information if said access control apparatus receives an access request to access the data from an access request source.

11. A recording medium that is readable by a computer and that stores a program therein for enabling said computer to carry out a managing sequence for checking data stored in N (N represents an integer of 2 or greater) memory devices which store data, generating data position information representative of the storage positions of data stored in any one of said N memory devices, and sending said data position information to M (M represents an integer of 2 or greater) access control apparatus which shares the N memory devices.

12. A recording medium that is readable by a computer which shares N (N represents an integer of 2 or greater) memory devices with other computers and which is capable of communicating with a managing apparatus, and that stores a program therein for enabling said computer to carry out:
a receiving sequence for receiving data position information representative of the storage position of data stored in any one of said N memory devices, from said managing apparatus; and
a control sequence for accessing the storage position indicated by said data position information if an access request to access the data is received from an access request source.
